(19) United States
(12) Patent Application Publication
(10) Pub. No.: US 2013/0193234 A1
(43) Pub. Date: Aug. 1, 2013

(54) OUTLET MECHANISM WITH PULSING AND ROTATING WATER EFFECT AND A WATER PROCESSOR WITH PULSING AND ROTATING WATER EFFECT

(71) Applicants: Huasong Zhou, Xiamen (CN); Li Jiang, Xiamen (CN); Jianmin Chen, Xiamen (CN); Renzhong Li, Xiamen (CN)

(72) Inventors: Huasong Zhou, Xiamen (CN); Li Jiang, Xiamen (CN); Jianmin Chen, Xiamen (CN); Renzhong Li, Xiamen (CN)

(73) Assignees: XIAMEN SOLEX HIGH-TECH INDUSTRIES CO., LTD., Xiamen, Fujian (CN); Huasong Zhou, Xiamen Fujian (CN)

(21) Appl. No.: 13/824,379

(22) PCT Filed: Sep. 22, 2011
(86) PCT No.: PCT/CN11/79986

§ 371 Date: Mar. 17, 2013

(30) Foreign Application Priority Data
Sep. 25, 2010 (CN) 201010290942.X
Sep. 25, 2010 (CN) 201020541074.3

(51) Int. Cl. B05B 1/34

(52) U.S. Cl. CPC B05B 1/341
USPC 239/466; 239/487

(57) ABSTRACT

The present invention is provided with an outlet mechanism with pulsing and rotating water effect, wherein comprising a body and a water processor, the body is disposed with an inlet end and an outlet end, a waterway connected to the inlet end and the outlet end is disposed inside the body, the waterway is disposed with a first cavity, the first cavity is disposed with an inlet hole connected to the inlet end, the section area of the inlet hole is smaller than the discharge area of the first cavity; the water processor is disposed with a corkscrew waterway, which is connected to the inlet end and the outlet end. The outlet mechanism is with simple structure, and it needs less components to be fitting to industrial production.

### FIELD OF THE INVENTION

The present invention relates to sanitary ware, especially to an outlet mechanism with pulsing and rotating water effect and a water processor with pulsing and rotating water effect.

### BACKGROUND OF THE INVENTION

An outlet mechanism with pulsing and rotating water effect is applied with beautiful and action water effect and better shower effect, so it's popular. A patent named a pulsing water massage components for a shower or a hand shower head with Chinese application number CN200780035770.8 and a utility model named a massage shower head with automatically rotation function with Chinese application number CN200820188839.2 are applied with a turbo member or a shower head with rotation function to achieve pulsing and rotating water by rotating itself to open or close the outlet hole.

Although above outlet mechanism can achieve pulsing and rotating water, they have disadvantages as below: 1. it needs higher water pressure to actuate, otherwise it's difficult to drive the rotation member to rotate; 2. the rotation member is easily wear in high rotating speed, reducing the service lift; 3. if the water is poor, such as with dust, the rotation member is easily blocked, the outlet mechanism is weak in stabilization. So that it needs to overcome above disadvantages to achieve pulsing and rotating water.

### SUMMARY OF THE INVENTION

The present invention is provided with an outlet mechanism with pulsing and rotating water effect and a water processor with pulsing and rotating water effect to solve the technical problems of the existing technology.

The first technical proposal of the present invention to solve the technical problems of the existing technology is as below:

An outlet mechanism with pulsing and rotating water effect, wherein comprising a body and a water processor I, the body is disposed with an inlet end and an outlet end, a waterway connected to the inlet end and the outlet end is disposed inside the body, the waterway is disposed with a first cavity I, the first cavity I is disposed with an inlet hole I connected to the inlet end, the section area of the inlet hole I is smaller than the discharge area of the first cavity I;

The water processor I is disposed with a corkscrew waterway I, which is connected to the inlet end and the outlet end.

In another preferred embodiment, the present invention further comprising a cover, which is fixed inside the waterway, the inlet hole I is disposed in the cover.

In another preferred embodiment, the first cavity I is formed between the cover and the water processor I.

In another preferred embodiment, the water processor I further comprising a throughout water hole I to connect to the first cavity I.

In another preferred embodiment, the waterway further comprising a second cavity I, the discharge area of which is larger than the section area of the water hole I.

In another preferred embodiment, the second cavity I is formed between the water processor I and the outlet end.

In another preferred embodiment, the number of corkscrew waterway I is two, two corkscrew waterways I are is disposed at the outer periphery of the water processor I of symmetry.

In another preferred embodiment, the water processor I is fixed to the body to be in one combined.

The second technical proposal of the present invention to solve the technical problems of the existing technology is as below:

A water processor with pulsing and rotating water effect is disposed inside the waterway of the outlet mechanism assembly and disassembly and is disposed with an inlet hole, an outlet hole II, a water cavity and a rotating body;

The rotating body is disposed inside the water cavity, the water cavity is disposed with a first cavity II, the rotating body is disposed with at least a corkscrew waterway II disposed at the outer periphery of the rotating body, the section area of the inlet hole II is smaller than the discharge area of the first cavity II.

In another preferred embodiment, the water processor II is screwed to the waterway of the outlet mechanism, the rotating body is further disposed with a throughout water hole II and divided the water cavity into the first cavity II and a second cavity II, the first cavity II is connected to the second cavity II through the water hole II, the section area of the through hole II is smaller than the discharge area of the second cavity II.

Compared to the existing technology, the technical proposal of the present invention had advantages as below:

1. an outlet mechanism with pulsing and rotating water effect is disposed with a body and a water processor I, the water processor I can be directly assembled inside the waterway of the body as an entity with the body, the structure is compact and simple.

2. the waterway is disposed with a first cavity I, the discharge area of the first cavity I is larger than the section area of the inlet hole I, so that the surface pressure of the water reduces, cavitation happens inside the first cavity I, with the generation, shaped and burst of the air bubble, self-oscillation pulsing effect comes out, compared to the traditional technology that there is no water in the central of the water flow, the shower area of the present invention is more even with well water saving effect.

3. as the water processor I is fixed, it is disposed with a corkscrew waterway I, water flows from the inlet end into the outlet end, rotating water generates when flowing through the corkscrew waterway I, no outside force is needed to actuate the water processor I to rotate to generate rotating water.

4. as the water processor I is disposed with a throughout water hole I, the waterway is further disposed with a second cavity I between the water processor I and the outlet end, the discharge area of the second cavity I is larger than the section area of the water hole I, so that water turns into pulsing water in the first cavity I and flows into the second cavity I through the water hole, cavitation happens again to enhance the pulsing effect of the water.

5. as the corkscrew waterway I can be disposed at the outer periphery of the water processor I of the outlet mechanism, it is independent from the watery hole I and it will not interfere the respectively producing of the pulsing water and the rotating water.

6. as the corkscrew waterway II can be disposed in the end face of the water processor II, the structure of the water processor II is compact and simple.

7. the water processor II can be an independent components, which can be disposed inside the waterway of the outlet mechanism assembly and disassembly, it can be widely applied with high compatibility.

### BRIEF DESCRIPTION OF THE DRAWINGS

The present invention will be further descried with the drawings and the embodiments.

FIG. 1 illustrates the breakdown structure of the outlet mechanism with pulsing and rotating water effect of the first embodiment.

FIG. 2 illustrates the sectional view of the outlet mechanism with pulsing and rotating water effect of the first embodiment when pulsing and rotating water flows out of the outlet mechanism.

FIG. 3 illustrates the structure of the water processor of the first embodiment.

FIG. 4 illustrates the structure of the water processor of the second embodiment.

FIG. 5 illustrates the sectional view of the water processor of the second embodiment.

### REFERENCE SIGNS

Outlet mechanism with pulsing and rotating water effect 100; body 110; inlet end 111; outlet end 112; waterway 113; first cavity I 114; second cavity I 115; water processor I 120; corkscrew waterway I 121; water hole I 122; cover 130; inlet hole I 131; water processor II 200; inlet hole II 210; outlet hole 220; water cavity 230; first cavity II 231; first cavity II 232; rotating body 240; corkscrew waterway II 241; water hole II 242; screw 300.

### DETAILED DESCRIPTION OF THE EMBODIMENTS

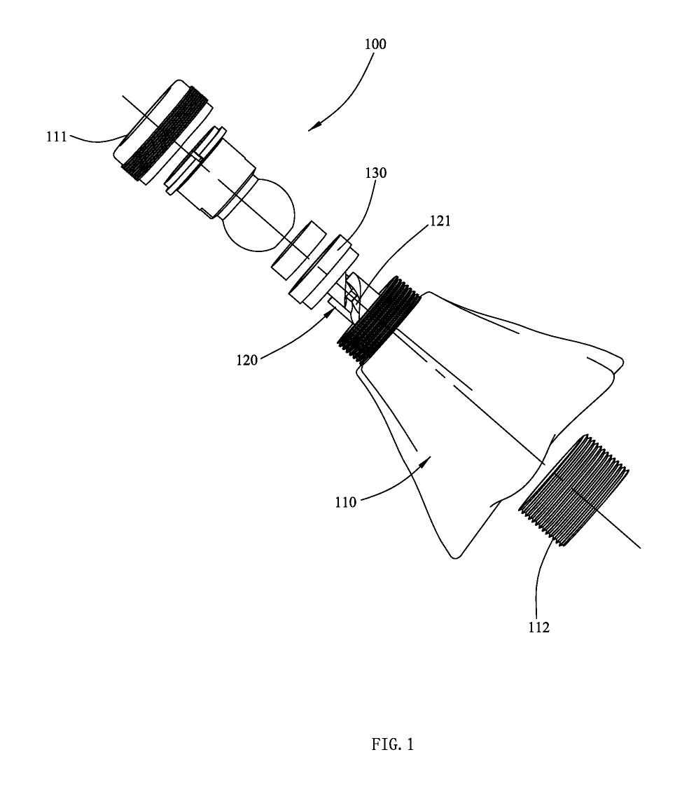

Refer to the FIG. 1 to FIG. 3 of the outlet mechanism with pulsing and rotating water effect of the first embodiment of the present invention.

The outlet mechanism with pulsing and rotating water effect 100 comprising a body 110, a water processor I 120 and a cover 130, thereinto:

The body 110 is disposed with an inlet end 111 and an outlet end 112, a throughout waterway 113 is disposed inside the body 110. The water processor I 120 is fixed to the body 110 in one combined, the water processor I 120 is disposed inside the waterway 113.

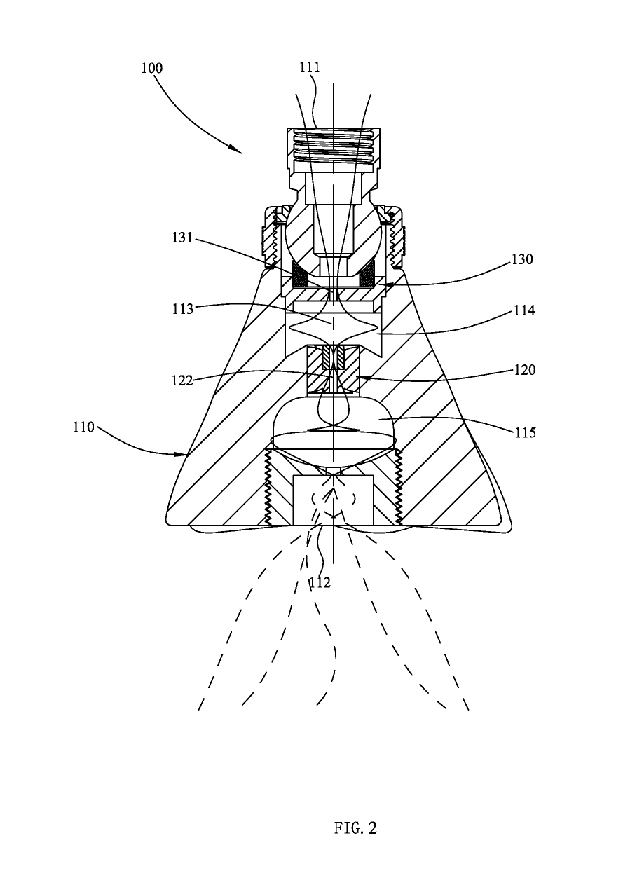

Two corkscrew waterways I 121 of symmetry are disposed at the outer periphery of the water processor I 120, the corkscrew waterways I 121 are not figured out in the FIG. 2 due to the view angle. The end face of the water processor I 120 is disposed with a through water hole I 122, the first cavity I 114 is connected to the second cavity I 115 by the water hole I 122, the discharge area of the second cavity I 115 is larger than the section area of the water hole I 122, the space between the water processor I 120 and the outlet end 112 is defined to be the second cavity I 115;

The cover 130 is disposed below the inlet end 111 and above the water processor I 120, the space between the cover 130 and the water processor I 120 is defined to be the first cavity I 114, the end face of the cover 130 is disposed with an inlet hole I 131 to connect to the inlet end 111, the discharge area of the first cavity I 114 is larger than the section area of the inlet hole I 131.

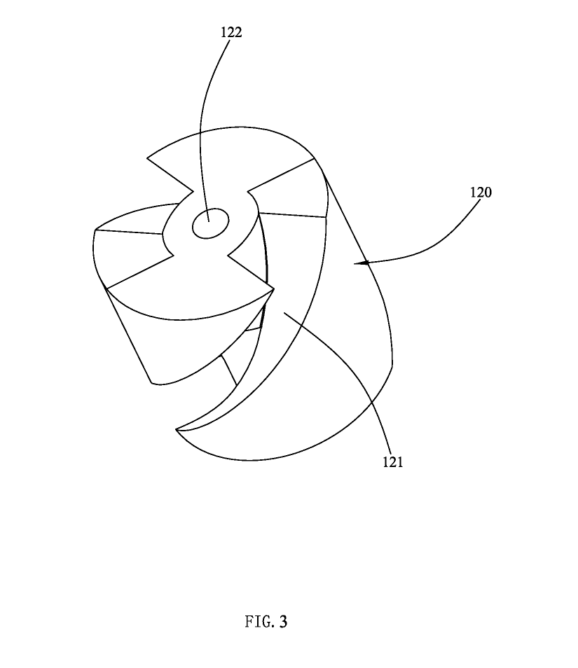

The discharge principle of the outlet mechanism with pulsing and rotating water effect of the present invention is figured out in the FIG. 2 and FIG. 3, turn on the water resource, water flows into the inlet hole I 131 of the cover 130 from the inlet end 111, as the section area of the inlet hole I 131 is smaller than the discharge area of the first cavity I 114, the flow rate of the water into the first cavity I 114 decreases suddenly, the surface pressure of the water reduces, cavitation happens inside the first cavity I 114, with the generation, shaped and burst of the air bubble, self-oscillation pulsing effect comes out, making the first cavity I 114 generated pulsing water, then water flows through the water processor I 120, one part of the water turns into rotating water with the effect of the corkscrew waterway I 121 then flows into the second cavity I 115, the other part of water flows into the second cavity I 115 through the water hole I 122 at the same time, as the section area of the water hole I 122 is smaller than the discharge area of the second cavity I 115, cavitation happens again, finally water flows out of the outlet end 112 with pulsing and rotating effect.

The pulsing water outlet principle of the present invention is applied with fluid dynamics actuation, the water processor I 120 and the outlet mechanism 100 are specially designed, so as the first cavity I 114 and second cavity I 115 of the waterway 113, that is to say, the section area of the water hole 131 is smaller than the discharge area of the first cavity I 114, the section area of the water hole I 122 is smaller than the discharge area of the second cavity I 115 to make cavitation happened inside the first cavity I 114 and the second cavity I 115, with the periodic variation of the air bubble of “generation, shaped, burst”, self-oscillation pulsing water flows out.

### The Second Embodiment

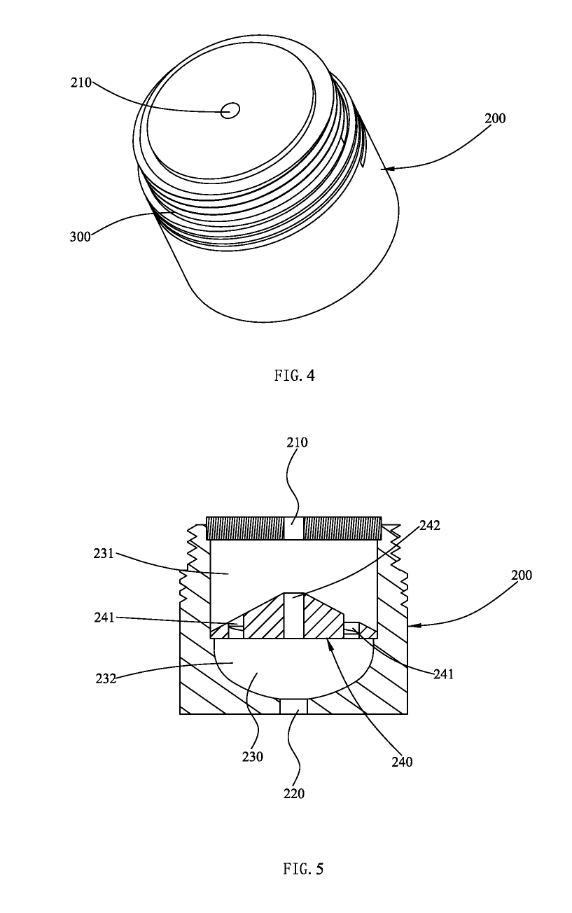

FIG. 4 and FIG. 5 illustrate a water processor with pulsing and rotating water effect 200 of the second embodiment of the present invention, the water processor with pulsing and rotating water effect 200 is disposed in the waterway of different outlet mechanism assembly and disassembly. In this embodiment, the pulsing and rotating water processor II 200 is screwed and connected to the waterway of the outlet mechanism, it comprising an inlet hole II 210, an outlet hole 220, a water cavity 230 and a rotating body 240, the inlet hole II 210 is disposed on the top of the water processor II 200 and connected to the inlet end of the outlet mechanism, the outlet hole 220 is disposed at the bottom of the water processor II 200 and connected to the outlet end of the outlet mechanism, the inner cavity of the water processor II 200 is the water cavity 230, the rotating body 240 is disposed inside the water cavity 230 and divided the water cavity 230 into a first cavity II 231 and a second cavity II 232 up and down, two corkscrew waterways II 241 are disposed on the end face of the rotating body 240, the end face of the rotating body 240 is further disposed with a throughout water hole II 242, which is connected to the first cavity II 231 and the second cavity II 232, the discharge area of the first cavity II 231 is larger than the section area of the inlet hole II 210, the discharge area of the second cavity II 232 is larger than the section area of the water hole II 242.

The number of the corkscrew waterway II 241 disposed in the end face of the rotating body 240 is not limited to one but can be more than one; such as the first embodiment, the corkscrew waterway II 241 can be disposed at the outer periphery of the rotating body 240.

The discharge principle of the water processor II 200 with pulsing and rotating water effect of the second embodiment is similar to the first embodiment, water flows into the first cavity II 231 through the inlet hole II 210, pulsing water generates inside the first cavity II 231, then water flows through the rotating body 240, one part of water turns into rotating water with the effect of the corkscrew waterway II 241 then flows into the second cavity II 232, the other part of water flows into the second cavity II 232 through the water hole II 242, pulsing water generates inside the second cavity II 232 as well, finally water flows out of the outlet end with pulsing and rotating effect.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

### INDUSTRIAL APPLICABILITY

The present invention is provided with an outlet mechanism with pulsing and rotating water effect and a water processor with pulsing and rotating water effect. The present invention is structural clever, the design is reasonable, it needs less components to be fitting to industrial production with well industrial applicability.

What is claimed is:

1. An outlet mechanism with pulsing and rotating water effect, wherein comprising a body and a water processor, the body is disposed with an inlet end and an outlet end, a waterway connected to the inlet end and the outlet end is disposed inside the body, the waterway is disposed with a first cavity, the first cavity is disposed with an inlet hole connected to the inlet end, the section area of the inlet hole is smaller than the discharge area of the first cavity;
The water processor is disposed with a corkscrew waterway, which is connected to the inlet end and the outlet end.

2. An outlet mechanism with pulsing and rotating water effect according to claim 1, wherein further comprising a cover, which is fixed inside the waterway, the inlet hole is disposed in the cover.

3. An outlet mechanism with pulsing and rotating water effect according to claim 2, wherein the first cavity is formed between the cover and the water processor.

4. An outlet mechanism with pulsing and rotating water effect according to claim 1, wherein the water processor further comprising a throughout water hole to connect to the first cavity.

5. An outlet mechanism with pulsing and rotating water effect according to claim 1, wherein the waterway further comprising a second cavity, the discharge area of which is larger than the section area of the water hole.

6. An outlet mechanism with pulsing and rotating water effect according to claim 5, wherein the second cavity is formed between the water processor and the outlet end.

7. An outlet mechanism with pulsing and rotating water effect according to claim 1, wherein the number of corkscrew waterway is two, the two corkscrew waterways are disposed at the outer periphery of the water processor of symmetry.

8. An outlet mechanism with pulsing and rotating water effect according to any 1, wherein the water processor is fixed to the body to be in one combined.

9. A water processor with pulsing and rotating water effect, wherein is disposed inside the waterway of the outlet mechanism assembly and disassembly and is disposed with an inlet hole, an outlet hole, a water cavity and a rotating body;
The rotating body is disposed inside the water cavity, the water cavity is disposed with a first cavity, the rotating body is disposed with at least a corkscrew waterway disposed at the outer periphery of the rotating body, the section area of the inlet hole is smaller than the discharge area of the first cavity.

10. A water processor with pulsing and rotating water effect according to claim 9, wherein the water processor is screwed to the waterway of the outlet mechanism, the rotating body is further disposed with a throughout water hole and divided the water cavity into the first cavity and a second cavity, the first cavity is connected to the second cavity through the water hole, the section area of the through hole is smaller than the discharge area of the second cavity.
